(19) United States
(12) Patent Application Publication
(10) Pub. No.: US 2022/0345419 A1
(43) Pub. Date: Oct. 27, 2022

(54) HUMAN SUPERVISION AND GUIDANCE FOR AUTONOMOUSLY CONFIGURED SHARED RESOURCES

(71) Applicant: Intel Corporation, Santa Clara, CA (US)

(72) Inventors: Thijs METSCH, Bruehl (DE); Adrian HOBAN, Cratloe (IE); John J. BROWNE, Limerick (IE)

(21) Appl. No.: 17/848,883

(22) Filed: Jun. 24, 2022

(51) Int. Cl. H04L 47/762; H04L 47/78; H04L 47/70; H04L 47/80

(52) U.S. Cl. CPC H04L 47/762; H04L 47/781; H04L 47/822; H04L 47/801

(57) ABSTRACT

Disclosed herein are guidance/supervision systems that may utilize guidance and supervision policies from various stakeholders, such as resource owner(s) and service owner(s), to provide guidance, supervision, and introspective analysis for an autonomous system that configures a group of shared resources. The system includes determining, based on predefined preferences associated with shared resources, a set of policies to guide an autonomous system in determining a set of configuration parameters for sharing the shared resources. The system also includes providing the set of policies to the autonomous system to configure the shared resources according to the set of configuration parameters.

### TECHNICAL FIELD

The disclosure relates generally to autonomous systems that manage shared resources, and in particular, to systems, devices, and methods for guiding the autonomous systems, supervising the autonomous systems, and assessing the decisions of the autonomous systems.

### BACKGROUND

Autonomous systems are becoming more prevalent for operating numerous types of systems, including those that operate vehicles, drones, robots, spaceships; those that operate factory equipment, heavy machinery, or precision tooling; and those that perform autonomous stock trading, just to name a few. In the area of computing, autonomous systems may be used to manage sharing of computing resources (hardware, software, etc.) for various types of shared computing resources such as core processing, data storage, networking functions, etc. Such computing resources may be pooled together and shared among many different users of the resources, as is often done in cloud computing. To pool and share resources, abstraction and/or virtualization may be used, where a group of shared resources may sit under a stack of higher layers, each of which may then be allowed to utilize one or more of the resources below. In particular, virtualization allows the resource provider (e.g., resource owner) to manage the way in which the underlying resources are used by the higher layers and/or in each instance of virtualization (e.g., by a service owner or the service owner's end-users) that may utilize the shared resources according to the management rules/configuration parameters.

As should be appreciated, the demands of service owners must be balanced with the demands of the resource owners and the limited supply of pooled resources. Managing the configuration parameters for the group of shared resources to meet these competing demands may be a complex task, and autonomous systems are often used to manage the configuration parameters for the group of shared resources. However, such autonomous systems may fail to satisfy the demands/preferences of service owners and resource owners while also optimizing utilization of the group of shared resources, leading to inefficient use of resources and/or unsatisfied service/resource owners.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary guidance/supervision system for an autonomously configured group of shared resources;

FIG. 2 shows an exemplary guidance/supervision system for an autonomously configured group of shared resources;

FIG. 3 illustrates exemplary graphs of two utility functions for different types of policy tradeoffs;

FIG. 4 shows an exemplary flowchart for how a guidance/supervision system may utilize guidance and supervision policies from resource owner(s) for guidance, supervision, and introspective analysis;

FIG. 5 shows an exemplary flowchart for how a guidance/supervision system may utilize guidance and supervision policies from service owner(s) for guidance, supervision, and introspective analysis;

FIG. 6 illustrates an exemplary schematic drawing of a device to guide, supervise, and introspectively analyze an autonomous system; and

FIG. 7 depicts a schematic flow diagram of an exemplary method for guiding, supervising, and introspectively analyzing an autonomous system.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

As should be appreciated, references to the “cloud” or “cloud computing” or “cluster computer” and the corresponding group of resources or cluster of resources should be understood to broadly encompass any type of infrastructure that is clustered and may encompass any number of different types of orchestration systems, including edge-computing.

As noted above, autonomous systems are often used to manage and share pooled resources (e.g., in a cloud or edge environment), where many different users may be given access to the pool of shared resources. Such pooled resources may include computing resources, networking resources, data storage resources, etc. To manage the pooled resources, the autonomous system must balance competing demands of the various stakeholders, including the demands from the owner(s) of the resources (e.g., resource owners) and each of the consumer(s) of the resources (e.g., service owners that may provide services/applications to end-users). A resource owner, for example, may wish to place limits on access to the resources in terms of timing, level of service, priority, amount of consumption, etc. On the other side, a service owner may make demands to have a certain level of access to the resources, including, for example number/availability of user connections, minimum level of service, minimum level of quality, etc. However, the autonomous system may not efficiently optimize these competing demands among all of the various stakeholders, each of which may make unique demands in different scenarios. The configuration parameters that the autonomous system selects for managing the shared resources may ultimately not provide an optimum solution, failing to correctly balance the tradeoffs or sufficiently arbitrate competing interests.

As should be appreciated from the description below, the disclosed guidance/supervision system may improve these short comings of autonomous systems by providing guidance (e.g., ways to steer the autonomous system to best implement the preferences of the various stakeholders (e.g., predefined preferences)), supervision (e.g., ways to steer mitigation strategies of the autonomous system by providing guardrails for the operation and arbitration between competing and/or conflicting interests (e.g., supervision rules)), and/or introspection (e.g., ways to mitigate faulty configurations or analyze the optimality of the stakeholder's preferences or the resulting configuration provided by the autonomous system (e.g., impacts) to enable investigate the dependability, safety, and efficiency of the overall system. Depending on the context of a given operational scenario, the disclosed guidance/supervision system may allow for automatic switching from fully autonomous mode to a human review mode, allowing a human to inspect the autonomous system's planned/selected configuration parameters and/or intervene to address the particular scenario.

As noted earlier, conventional autonomous systems may not efficiently manage competing stakeholder interests when setting configuration parameters of the shared group of resources, focusing instead on enabling and configuring the policies provided to them the by the stakeholder and enforcing them locally. These policies are often managed in a policy management framework that allow the service provider to enforce how their end-users are allowed to access and use the resources according to certain budget/cost constraints. Such frameworks may be set forth by standards organizations, and one such example, published by the European Telecommunication Standards Institute (ETSI), is called “Network Functions Virtualisation (NVF); Architectural Framework” (ETSI GS NFV 002 V1.1.1) and was first published in October 2013. The Architectural Framework document provides a high-level functional architectural framework and design philosophy of virtualized network functions and of the supporting infrastructure. ETSI NVF describes the provides a framework for enabling and exploiting a dynamic construction and management of network functions graphs or sets. It also provides a framework for managing their relationships regarding their associated data, control, management, dependencies and other attributes.

However, conventional policy management frameworks are often binary with fixed configuration parameters. For example, if the service provider wants to limit cost of assigned resources, the policy may limit the number of users to a fixed value, such a “allow no more than 100 users.” But this may not be the most effective way to manage cost. As other examples, the service provider may provide a fixed limit to the configuration parameter settings, such as requiring a particular configuration setting or by limiting the configuration setting to a predetermined list. However, such binary enforcement of configuration settings provides no ability to flexibly adapt to the actual usage context or the ultimate reason why the service provided placed a limit on the specific configuration parameter. If there are conflicts, the management framework may only be able to identify the conflict, and remove it by changing the settings to non-conflicting values. Such conflict resolution may fail to identify other configurations that may provide a better trade-off between competing demands. This approach to conflict and configuration often result in a “one size fits all” approach, leaving potential efficiency gains untapped.

In conventional systems, the type of human intervention that is provided is not often separate from the autonomous system, where the human may simply provide an over-ride to a particular configuration parameter, causing the autonomous system and the human intervener to contend for control over the same configuration parameter, infrastructure, and/or services. When a human intervenor bypasses automatic configuration of a given parameter (e.g., through an over-ride, unplanned changes, or through a side-channel like secure shell (SSH) or basic input/output system (BIOS) configuration settings), the automated system may be unaware of such a change and not be able to account for the setting in its autonomous decision making. Changes made by the human intervenor, then, are not proliferated by the automated systems. In addition, human over-rides may create undesirable security issues or confusion to the autonomous decisions, creating automated mis-configuration issues (or a suspicion thereof).

By contrast, the disclosed guidance/supervision system may enable ways to manage autonomously configured shared resource systems by supervising, guiding, and analyzing the autonomous systems that may be controlled, for example, in artificial intelligence operator fashion using artificial intelligence (AI) models or machine learning (ML) models to implement the preferences of resource owners and/or service ours. The disclosed guidance/supervision system may enable an in depth analysis into guiding such autonomous systems to make the most efficient use of infrastructure and services, steering the system to implement the preferences (e.g., including cost preferences) of various stakeholders and enable untapped efficiency gains. The disclosed guidance/supervision system may move away from a fixed rules-based control to a more fluid control that may adapt over time and to the particular context.

As examples of the guidance that the disclosed guidance/supervision system may provide, these may include situational or goal-based policies (e.g., predefined preferences) instead of binary settings. In this manner, each operator may specify its own way of operation. For example, a telecommunications operator may provide the following guidance and/or preferences: operate my high-end platforms at 80% utilization; operate my low end platforms at 40% utilization; the power usage of low-paying customers should not exceed a maximum power consumption level for this set of customers; this particular slice should run according to these parameters while this other slice should run according to these other parameters; run workloads categorized as best effort workloads according to certain parameters while running workloads categorized as guaranteed service workloads according to another set of parameters; run this service with green energy, if possible, and if not possible, reduce the energy consumption of the service by 40%; providing time-based preferences such as to start a certain guidance at a start time and end the guidance at an end time or to enable a supervision task during a particular time period or when a particular event occurs; etc.

As examples of the supervision that the disclosed guidance/supervision system may provide (e.g., supervision rules), these may include preferences beyond merely alert management, allowing definition of mitigation preferences for addressing competing/conflicting demands. For example, if an error occurs in a particular context, try these two mitigation techniques in this order (e.g., first try to scale out, and if that does not resolve the error, then move the process, etc.); maintain the workload at this particular location so that even if the internet connection goes down while the edge connection remains, processing may continue; etc.

As examples of the analysis or introspection that the disclosed guidance/supervision system may provide, these may include analyzing or previewing what may occur if the guidance and/or supervision rules are adopted (e.g., impacts). This allows for inspection and effect calculus on the set of guidance and/or supervision rules. For example, the analysis may include an impact confirmation, that asks whether a resulting override is intended; or the analysis may include a results-based confirmation, where if the proposed combination of rules may result in a particular event occurring, asking whether this is the intended result; the analysis may include audit logs that record information about the intended goal of rule/changes (e.g., the reason why a change was applied to the environment) and not just about what changes were made. As should be appreciated, these are just examples of the types of guidance, supervision, and insights that the disclosed guidance/supervision system may provide.

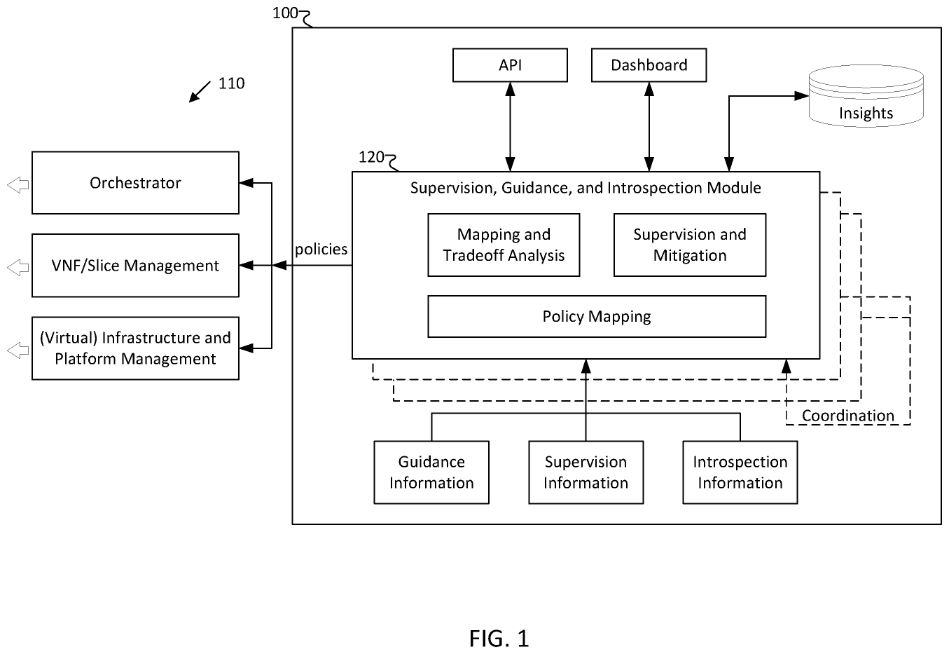

FIG. 1 shows a guidance/supervision system 100 that may be used in the context of a management framework 110 to autonomously configure a group of shared resources. As shown in FIG. 1, the management framework 110 may include an orchestrator, virtual network functions/slice management, and (virtual) infrastructure and platform management (e.g., a full Management and Orchestration (MANO) stack according to ETSI's NVF Architectural Framework (described in, for example, ETSI GS NVF 002 V1.1.1)) that receive policies (e.g., configuration parameters) from the guidance/supervision system 100 for implementing in the management framework 110. The guidance/supervision system 100 may include a supervision, guidance, and introspection module 120 that may perform mapping and tradeoff analysis, supervision and mitigation, and policy mapping, using the various inputs and preferences of the stakeholders (e.g., guidance information, supervision information, and introspection information). The supervision, guidance, and introspection module 120 may be operated using an application programming interface (API) and/or a dashboard, and it may have access to an insights database of historical/contextual information for optimizing the configuration parameters of the group of shared resources. The guidance/supervision system 100 may also provide coordination among several supervision, guidance, and introspection modules 120 (e.g., per cluster) that may be, for example, focused on the management of different layers of the stack (e.g., by the virtualized infrastructure manager (VIM), the network functions virtualization orchestrator (VFVO), etc.). As should be appreciated, the coordination could be peer-to-peer or hierarchical, depending on the architecture of the overall system.

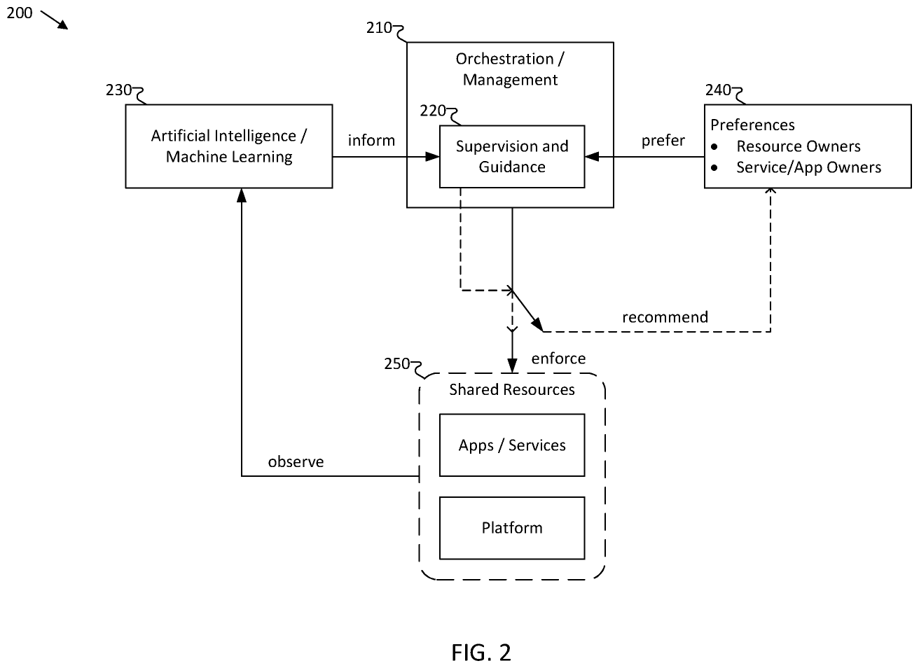

FIG. 2 shows a guidance/supervision system 200 that may be used in the context of an orchestration/management framework 210 to autonomously configure a group of shared resources 250 that form a platform for providing apps/services. The guidance/supervision system 200 may receive preferences 240 from resource owners of the group of shared resources 250 and from service/app owners of the apps/services that utilize the group of shared resources 250. Based on the preferences 240, the guidance/supervision system 200 may provide guidance and supervision to an autonomous system that may set policies (e.g., configuration parameters) according to which the group of shared resources 250 are configured. An artificial intelligence/machine learning model 230 may observe the actual usage information about how the apps and services use the group of shared resources 250, and provide information to the guidance/supervision system 200 about the effectiveness of the policies actually selected to manage the shared group of resources 250. The guidance/supervision system 200 may use the usage/effectiveness information to provide insights into the preferences 250 of the stakeholders, such as whether and to what extent the preferences 250 are achieving their intended (e.g., predefined goals).

In addition, the guidance/supervision system 200 may operate in a semiautonomous mode, where, instead of immediately enforcing the policies determined from preferences 240 of the resource owners and service owners, the guidance/supervision system 200 may provide a recommended set of policies that may be reviewed by the resource/service owners (e.g., with human intervention) before it is enforced as an actual policy for managing the group shared resources 250. In this manner, the guidance/supervision system 200 may switch from a closed-loop control for enforcing polices to an open loop control, or a hybrid thereof. As should be appreciated, the guidance/supervision system 200 may switch between closed-loop and open-loop control based on any type of triggering event, such as an observed parameter exceeding a threshold value, a warning of an unresolvable conflict, a change to a particular type of configuration parameter, etc. In a hybrid mode, for example, the guidance/supervision system 200 may operate in a closed-loop control for a certain configuration parameter/policy or group of configuration parameters/policies while other configuration parameters/policies or group of configuration parameters/policies may operate in open-loop control. In other words, each configuration parameter/policy may be individually configurable for open-loop or closed-loop control.

The guidance and supervision aspects of an autonomous guidance/supervision system (e.g., guidance/supervision system 100 and/or guidance/supervision system 200) may be based on a utility function. Utility functions may define the way in which the autonomous system is to behave in a given context, and a utility function may provide parameters that the various stakeholders may tweak based on their goals/preferences. Based on the utility function the guidance/supervision system may perform a trade-off analysis to determine a set of optimal enforceable policies and mitigation strategies at a given time and in a given context. This may provide for a dynamic system that may adapt configuration parameters to the different contexts that may change over time and under different usage conditions.

Once the guidance/supervision system has analyzed the preferences (e.g., the utility functions) provided by the various stakeholders and its has determined the optimal set of enforceable policies for the given time and context, the selected policies need to be enforced on the actual subcomponents of the autonomous system (e.g., using dynamic policies). In other words, the autonomous system translates the selected guidance/supervision policies into a set of configuration parameters (e.g. policies) for the various subcomponents managed by the autonomous system. For example, assume the guidance/supervision system instructs the autonomous system to enforce a guidance policy such as: run [symbol] service [symbol] with max [symbol] utilization [symbol] of [symbol] resource [symbol] while maintaining my service level agreement (SLA), as measured by [symbol] SLO [symbol] . In this example, [symbol] service [symbol] may be any end user service (e.g., 5G core, IMS, ORAN, broadband service, etc.), [symbol] utilization [symbol] is cardinal value for the resource, [symbol] resource [symbol] may be total infrastructure resources (e.g., service, compute, memory, storage, network, and/or power/facility resources).

Based on the guidance policy, the autonomous system may select a set of policies (e.g. configuration parameters/policies) for the underlying infrastructure resources according to the configurable parameters/policies of the particular subdomain. Thus, for a service subdomain, the parameters may include fractions of a network slice, quality of service (QoS) setting for each slice, etc. For the compute subdomain, the parameters may include CPU utilization of the service measured as measured by the operating system (OS), data plane development kit (DPDK)/vector packet processing (VPP) utilization as measured by DPDK/VPP application busyness telemetry, network interface bandwidth utilization as measured by the OS, etc. For the memory subdomain, the parameters may include memory bandwidth as measured by a bandwidth monitor, cache utilization as measured by a cache monitor, a memory contention as measured by a memory contention monitor, etc. For the storage subdomain, the parameters may include storage capacity as measured by a storage monitor, a storage latency, a storage health as measured by a storage health meter, etc. For the network subdomain, the parameters may include receive and transmit rates of network interfaces, packet drops of network interfaces, etc. For the facilities subdomain, the parameters may include thermal configuration parameters, power configuration parameters, up-time parameters, etc.

For the platform technical settings (e.g., of the system) settings, the parameters may include memory resource parameters (e.g., RDT, CAT, and MBA), power parameters (e.g., SST-BF, SST-CP, SST-TP, P-states, C-states, RAPL), network interfaces parameters (e.g., rate controllers, traffic shapers on NICs and infrastructure processing units (IPUs)), solid state drives (SSDs) and non-volatile memory (NVME) disk quotas, CPU core pinning, non-uniform memory access (NUMA) node configuration and socket assignment, encryption/compression rate controller (e.g., QAT rate controller)), encryption/compression power controls (e.g., QAT power controller), peripheral component interconnect (PCI) link adaptive power control settings, NIC/IPU power states, NIC dynamic firmware programming (DDP) configuration, CPU uncore frequency configuration, NIC/IPU P4 configuration, guest OS configurations (e.g., RT kernel), host OS configurations (e.g., RT kernel, CPU governor, etc.), etc.

Similar to guidance policies, supervision/mitigation policies (e.g., policies to switch from fully automatic settings (closed loop) to previewed settings that are first approved by a human operator before enforcement (open loop), mitigation policies, policies to switch from open loop to closed loop, etc.) may impact the following exemplary sets of configuration parameters (e.g. policies) that may be monitored or enabled, and the corresponding impact may then be monitored for compliance with a predefined threshold (e.g., a warning criterion). For example, for policies related to switching from closed loop to open loop, impact parameters may include a length of time the service is outside the SLA, a service outage is detected, a service error threshold is exceeded, a service KPI anomaly is detected, an infrastructure anomaly is detected, a security alert is received from security information and event management (SIEM) or security operations center (SOC), a scaling event hits an upper limit, a new deployment is detected that could cause resource constraints, etc.

For policies related to mitigation, impact parameters may include enabling policies such as: if service X fails try to failover to service Y; all automated service deployments (e.g., of the network functions virtualization orchestrator/service orchestrator (NFVO/SO) must be approved by a particular group of human roles/actors; approved actor-initiated rollback of software upgrades to infrastructure; approved actor-initiated rollback of software upgrades to services; human actor initiated last software-defined network (SDN) changes rollback; all requests to Kubernetes (e.g., K8s) from service orchestration system must be approved by approved human actor; approved actors are granted access to infrastructure control interfaces (e.g., SSH) to make direct infrastructure changes for a particular time; alternative security policies applied to the cluster (e.g. restricting/relaxing access to sub-systems), ramp-up observability (metrics/logs/traces) level of details for a particular period (e.g., to have greater insight potential into the impacts of a change); etc.

For policies related to switching from open loop (human-approved changes) to closed loop (fully autonomous), impact parameters may include enabling policies such as: time-based switch back to closed loop; a timeout-based (e.g., no activity) switch back to closed loop (e.g., to mitigate the problem of a human actor neglecting to restore fully autonomous state); manually triggered (e.g., via a human user interface); post-activation of an updated configuration/deployment; etc. As should be appreciated, these configuration parameters and policies of the underlying infrastructure resources are merely exemplary and the guidance/supervision policies may impact any type of configuration parameters and policies of the underlying infrastructure resources that may be enforced by the autonomous system.

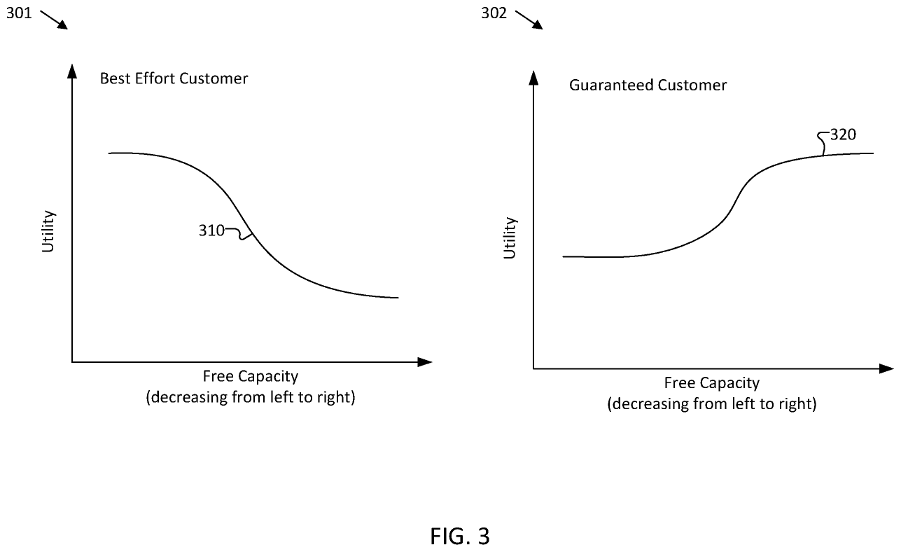

FIG. 3 shows examples of two different utility functions in an exemplary system in which access to the shared resources is provided to service owners in one of two categories: a best effort customer or a guaranteed customer. The resource owner may prefer to prioritize serving guaranteed customers over best effort customers so that guaranteed customers are provided a guaranteed level of service (e.g., in terms of their requested service level objective (SLO), resource allocation(s), etc.) even when free capacity is at a very low level, whereas best effort customers may receive a reduced level of service at times when free capacity is very low. Thus, from the perspective of the autonomous system that is guided by a guidance/supervision system (e.g., guidance/supervision system 100 and/or guidance/supervision system 200), the utility of the best effort customer may be high (e.g., they are provided a higher weighting) when there is high free capacity, but as free capacity decreases, the utility will also decrease. This is shown in graph 301, which plots utility as a function of free capacity along curve 310 for a best effort customer, where the free capacity axis decreases from left to right. For a guaranteed customer, the utility may be low when there is high free capacity, but as free capacity decreases, the utility will increase. This is shown in graph 301, which plots utility as a function of free capacity along curve 320 for a guaranteed customer. As should be understood, from the perspective of the autonomous system, utility may be understood as any function/weighting that may influence the decision making process of the automated system.

As should also be appreciated, the utility functions plotted in FIG. 3 are merely exemplary, and the curve of the utility function may take any shape and may relate to any type of preference, policy, or goal that the resource owner or service owner may wish to provide, enforce, or achieve. Moreover, each utility function may include adjustable aspects, and the aspects may be weighted based on a given context. For example, a service owner may be motivated to provide the best performance per financial cost (e.g., per dollar) and/or per unit of energy used (e.g., per Watt). The current state may define the resource allocations currently associated with the workload. The desired state may be a measure of how close an action would bring the current state towards the desired state, which may include forward looking aspect(s) or forecast(s). The financial attribute may be the cost for running the workload after a potential action has been performed. Other attributes may include the priority of the workload or a weighted list of what is more important (e.g., is compliance in the 99th percentile (P99 compliance) or compliance in the 50th percentile (P50 compliance) more important, etc.). Any of these attributes may be adjusted/provided by the service owner for use in the utility function.

As another example—this time from the perspective of a resource owner—the resource owner may be motivated to receive the best return on investment (ROI), best total cost of ownership (TCO), and the best power efficiency (PoE) (e.g., performance per Watt). The current state may be the overall capacity (e.g., headroom) of the system. The desired state may be an efficient fulfilment of a set of objectives in accordance with service level agreements (SLAs) (e.g., across tenants). The financial attribute may be ROI and/or TCO. Other attributes may include balancing multiple-tenancy (e.g., based on the priority of each tenant), over-provisioning of resources; resource contention (e.g., capacity), etc. Any of these attributes may be adjusted/provided by the resource owner for use in the utility function.

As another example from the perspective of a resource owner, the resource owner may be motivated to ensure customer retention and temporarily (e.g., without additional infrastructure) boost capacity. The current state may be best effort models selected for cost savings reasons, but how well the best effort model behaves may have an impact on customer retention patterns. Thus, the desired state may be a temporal boost to capacity for best effort users so as to minimize their disruptions. The financial attribute may be customer retentions of best effort customers due to fewer degradations they have experienced. Any of these attributes may be adjusted/provided by the resource owner for use in the utility function.

An example utility function (Utility_{policy}) is provided below that may serve as the policy function provided by the guidance/supervision system to the autonomous system for selecting configuration parameters:

$$\frac{1}{\begin{matrix}( {w}_{a} * \frac{capacity}{capacity + \frac{1}{cost}} ) + \\ ( {w}_{b} * \frac{{pred}_{s l o}}{{goal}_{s l o}} ) + ( {w}_{c} * ( priority * headroom ) ) + …\end{matrix}}$$

In this example of a utility function, wₐ, w_{b}, and w_{c} are weights that may be provided in the function to prioritize/deprioritize the corresponding attribute(s) with which it is multiplied. In addition,

$$\frac{{pred}_{s l o}}{{goal}_{s l o}}$$

may be understood as the predicted service level objective (predₛₗₒ) divided by the target service level objective (goalₛₗₒ), where the predicted service level objective (e.g., latency) may be predicted by an AI/ML model that predicts expected service levels (e.g., expected latency) under a given set of observable conditions. As should be appreciated, this is merely one example of a utility function, and any type of utility function may be used, using any number of attributes and/or associated weightings to define the policy(s) of the various stakeholders that are used to guide the autonomous system.

In addition to the guidance and supervision aspects, the autonomous guidance/supervision system (e.g., guidance/supervision system 100 and/or guidance/supervision system 200), may also include an introspection tool that analyzes the effectiveness of the guidance and supervision policies. The introspection tool may be understood a providing intermittent and/or continuous assessments of both the initial guidance policies (e.g., that steer implementation of stakeholder preferences) as well as the supervisory policies (e.g., that steer mitigation/arbitration of competing/conflicting interests). The guidance/supervision system may perform introspection frequently, given that the actual environment may change dynamically, and that which may have been viewed as a reasonable guidance/supervisory policy for the environment at the time it was applied may no longer be optimal for the current environment.

The introspection tool may be used to analyze policies of both the service owner and the resource owner, and the introspection may be performed at any time after the guidance/supervision policies have been input into the system. The guidance/supervision system may perform introspection continuously (e.g., in real-time, at regular or irregular intervals, etc.) or may be event based (e.g., based on a user input/request, a warning/alert, or other trigger). In addition, the guidance/supervision system may perform a prospective introspection, where the proposed guidance/supervision policies may be analyzed before actual implementation by the system to predict potential issues associated with the proposed guidance/supervision policies. To predict potential issues (e.g., unresolvable conflicts, inefficiencies, unexpected performance, etc.) associated with the proposed guidance/supervision policies, the guidance/supervision system may use a database (e.g., a knowledgebase of historical configuration parameters that resulted from various policies in different scenarios) combined with an AI/ML model to predict likely outcomes and associated issues.

The introspection tool may use introspection rules or algorithms to analyze a range of potential impacts to the overall system, including, as non-limiting examples, performance, dependability, security, and/or sustainability. Performance assessments may include latency, jitter, throughput, and/or scalability, although the introspection tool may analyze any aspect of system performance. As a non-limiting example of a performance-related rule and its associated warnings, a resource owner may have a goal of providing an environment with market-leading latency, and pursuant to that goal, specifies a guidance policy that sets 55% capacity utilization as the trigger point for scaling. At the same time, a service owner may have a goal of prioritizing cost and sustainability and specifies a guidance policy that set 80% capacity utilization as the trigger point for scaling. The introspection tool may analyze these guidance policies (e.g., either before implementation as a predicted conflict or after implementation as an actual conflict) and provide a warning message to the resource owner and/or service owner as to the conflict in guidance specification. For example, the message to the service owner may be a warning indicating that the latency/jitter performance metric is not achievable. The warning message to the resource owner may indicate that the service owner's guidance policy impacts latency predictability across particular service owners due to the shared environment.

As an example of dependability metrics, these may include availability, safety, and/or predictability, although the introspection tool may analyze any aspect of system dependability. To provide a non-limiting example of a dependability-related rule and its associated warnings, a service owner may have a goal of maximizing availability through a spread deployment model and sets a guidance policy of anti-affinity deployments of the microservice replicas of their service. At the same time, a resource owner may have a goal of limiting privacy risks and sets a guidance policy that prefers affinization/co-location of service owner components. At initial deployment, the introspection tool may analyze these guidance policies and determine that they do not raise any issues. However, after new services are deployed (or are planned for deployment) that drive up utilization of the group of shared infrastructure resources, the introspection tool may re-analyze these guidance policies in the current environment (or for the predicted environment) and determine that the policies now conflict. As a result, the introspection tool may determine that under current/predicted conditions, the capacity demands do not permit enforcement of both polices. The warning message that the introspection tool may provide to the service owner may indicate that the target availability is not achievable. The warning message to the resource owner may indicate that a service owner's guidance policy impacts predictability requirements of particular service owners due to the shared network interface card (NIC) capacity demands.

As an example of security metrics, these may include trust, risk, privacy, and/or confidentiality, although the introspection tool may analyze any aspect of system security. To provide a non-limiting example of a security-related rule and its associated warnings, a service owner may have a goal of maximizing input/output capacity potential through a spread deployment model and sets a guidance policy of anti-affinity deployments of the microservice replicas of their service and also requires maximum privacy through avoidance of co-location with other tenants. At the same time, a resource owner may have a goal of limiting co-location with other tenants and sets a guidance policy that prefers affinization/co-location of service owner components. At initial deployment, the introspection tool may analyze these guidance policies and determine that they do not raise any issues. However, after new services are deployed (or planned for deployment) that drive up utilization of the group of shared infrastructure resources, the introspection tool may re-analyze these guidance policies in the current environment (or for the predicted environment) and determine that the policies now conflict. As a result, the introspection tool may determine that under current/predicted conditions, the capacity demands do not permit enforcement of both polices. The warning message the introspection tool may provide to the service owner may indicate that the target privacy risk level is not achievable. The warning message to the resource owner may indicate that a service owner's guidance policy impacts privacy risk requirements of particular service owners due to the co-location capacity demands.

As an example of sustainability metrics, these may include power consumption, carbon emissions, and/or greenhouse gas emissions, although the introspection tool may analyze any aspect of system sustainability. To provide a non-limiting example of a sustainability-related rule and its associated warnings, a first service owner may have a carbon footprint goal and sets a guidance policy requiring a maximum carbon footprint target for their deployment. In addition, a second service owner may have a customer satisfaction goal and sets guidance policy requiring a lowest latency target and a highest performance target for their deployment. At the same time, a resource owner may have a goal of providing reliable performance and sets a guidance policy that prefers performance targets over sustainability targets. At initial deployment, the introspection tool may analyze these guidance policies and determine that they do not raise any issues. However, after new services are deployed (or are planned for deployment) that drive up utilization of the group of shared infrastructure resources, meaning that if low-power modes are maintained in respect of the first service owner's goal, the second service owner may not meet latency/performance targets (or, if a high-power mode is used to meet the second service owner's latency/performance targets, the first service owner's carbon footprint goal cannot be met. When the introspection tool re-analyzes these guidance policies in the current environment (or for the predicted environment), it may determine that the policies now conflict. As a result, the introspection tool may determine that under current/predicted conditions, the capacity demands do not permit enforcement of both polices. The warning message the introspection tool may provide to the first service owner may indicate that its carbon footprint requirement is not achievable (and/or provide a warning to the second service owner indicating that the latency/performance targets are not achievable). The warning message to the resource owner may indicate that there is a conflict between the two service owner's policies due to the increased capacity demands.

Feedback from the introspection tool may be provided to the relevant persons in the environment, and the introspection may use, as an example, a Role Based Access Control model to identify relevant persons. As should be appreciated, it may be important to limit sharing of the feedback to only those persons the introspection tools identifies as relevant so that unauthorized persons do not receive the introspection feedback. For example, it may be inappropriate to share with service owners infrastructural insights that may be derived from introspection feedback, inclusive of multi-tenant views.

As the autonomous guidance/supervision system (e.g., guidance/supervision system 100 and/or guidance/supervision system 200) analyzes the guidance/supervision policies and arbitrates potentially conflicting rules, the resulting configuration parameters may have an impact on overall system behavior. Thus, the guidance/supervision system may also identify in an arbitration result how the policies were balanced and/or to what extent each policy was satisfied/non-satisfied or was prioritized/deprioritized when arriving at the arbitrated result. As should be appreciated, this information may be useful to allow for adjustments/training for the autonomous system and to enable human intervention to adjust the balance of the arbitration, which policies should be prioritized, or the extent to which policies must be enforced. In addition, the guidance/supervision system may include a workflow for triggering re-arbitration, where the workflow may have inputs (e.g., long-lasting or temporal inputs) that may impact how often or when the guidance/supervision system performs reprioritizations.

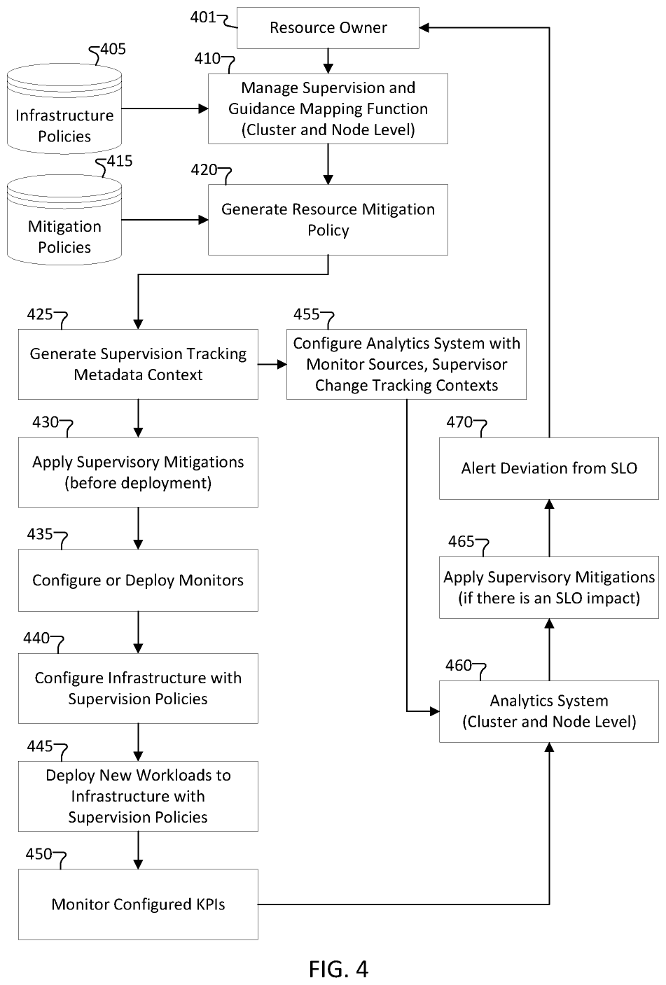

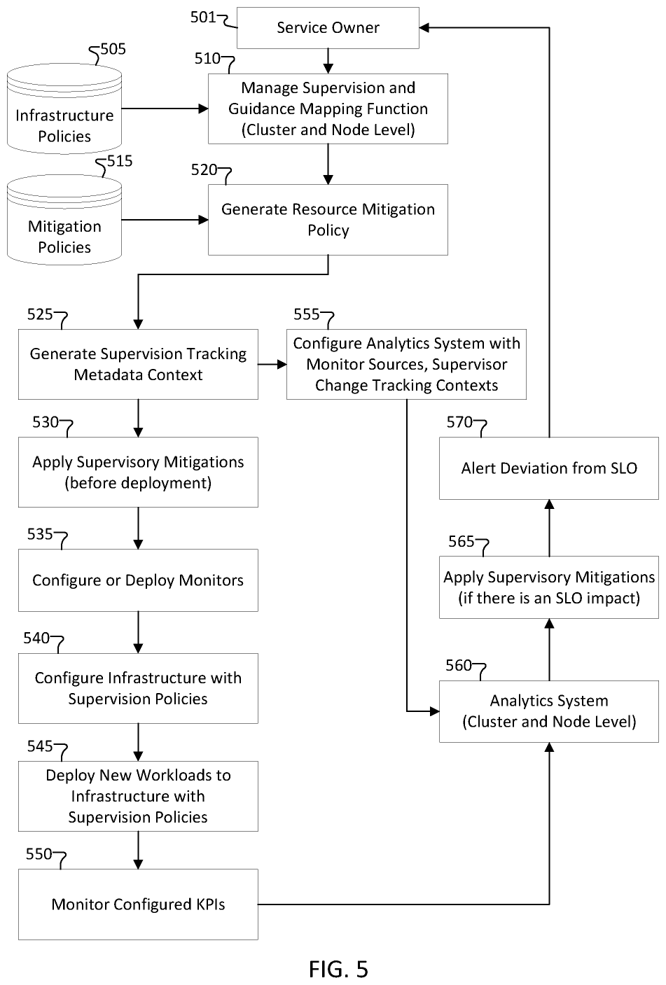

FIGS. 4 and 5 show detailed flowcharts for how a guidance/supervision system (e.g., guidance/supervision system 100 and/or guidance/supervision system 200) may utilize guidance and supervision policies from resource owner(s) (FIG. 4) and/or service owner(s) (FIG. 5) to guide, supervise, and introspectively analyze an autonomous system. As shown in FIG. 4, a resource owner 401 may provide input, in 410, to the guidance/supervision system's supervision and guidance mapping function(s) (e.g. utility function(s)). As discussed above, the resource owner may have particular interests in running a specific slice in predefined way; subdividing workloads into predefined types that are associated with different performance, priority, trade-offs, etc.; changing the allocation of assigned resources; etc. The guidance/supervision system may utilize a database 405 of infrastructure polices that may provide, for example, templates for achieving predefined goals, steering the autonomous systems to a particular result, or that reflect the configurable functionalities of the group of shared resources. The guidance/supervision system may, in 420, generate a resource mitigation policy(s) based on the input from the resource owner 401 and/or the selected mapping function(s). The guidance/supervision system may utilize a database 415 of predefined mitigation policies to construct the mitigation policies by mapping supervision to specific infrastructure resource configuration policies/parameters (e.g., modify the processor frequency/voltage tuning (such as SST), low level processor resource tuning (e.g. cache, memory, etc. such as RDT, CAT, MBA), sleep/hibernate states such as C-state, P-state, etc.).

Next the guidance/supervision system may, in 425, generate a supervision tracking metadata context. The supervision tracking metadata context may be provided in 455, to a supervisor that may configure an analytics system with monitor source supervisor change tracking contexts, etc., that are tied to a specific guidance. This may then be provided to, in 460, an analytics system that provides for monitoring the impact of human supervision and guidance over the autonomous system. If necessary (e.g., to address an impact to or issue with a service level objective (SLO)), the guidance/supervision system may apply, in 470, supervisory mitigations in an attempt to resolve the SLO impact/issue. The guidance/supervision system may also provide an alert to the resource owner 401 that there is a deviation from the SLO along with information about the type, extent, and criticality of the deviation, the selected/proposed mitigation, etc.

The guidance/supervision system may also use, in 430, the supervision tracking metadata context from 425 to apply (pre-deployment) the supervisor mitigations to the system. Then, in 430, the guidance/supervision system may configure and/or deploy monitors. The monitors may be configured or deployed, for example, with resource key performance indicators (KPIs) that may be used to support resource monitoring for the impact of changes in guidance/supervision policies. If the impact is satisfactory, the guidance/supervision system may, in 440, set the configuration parameters/policies for the infrastructure according to the supervision policies. In essence, this may be an override of the autonomous system's configuration parameters/polices for the resources with the supervisor-selected policies. The guidance/supervision system then, in 445, deploy new workloads to the infrastructure using the supervisor-selected policies. The guidance/supervision system may then, in 450, monitor these deployed policies as to the configured KPIs, which may also be provided to the analytics system 460 for monitoring the impact of the new supervision policies. As should be appreciated, the guidance/supervision system may repeat this process to allow for continuous (e.g., real-time) monitoring, updating, and fine-tuning, or intermittently where the process is triggered randomly, at time-based intervals, event-based triggers (e.g., an alert condition), etc.

FIG. 5 shows a similar flowchart of guidance/supervision system but from the perspective of service owner(s) and how a service owner may influence the system. For example, a service owner 501 may provide input, in 510, to the guidance/supervision system's supervision and guidance mapping function(s) (e.g., utility function(s)). As discussed above, the service owner 501 may have particular interests in guiding the system to a particular utilization rate for a particular type of resource, setting a particular power consumption of a particular end-user, selecting resources that are powered with green energy, etc. On the supervision side, the service owner 501 may wish to provide mitigation preferences, such as providing a prioritized order of mitigation techniques or a preferred location for a given workload. The guidance/supervision system may utilize a database 505 of infrastructure polices that may provide, for example, templates for achieving predefined service goals, steering the autonomous systems to a particular service result, or that reflect the service-configurable functionalities of the group of shared resources. The guidance/supervision system may, in 520, generate a resource mitigation policy(s) based on the input from the service owner 501 and/or the selected mapping function(s). The guidance/supervision system may utilize a database 515 of predefined mitigation policies to construct the mitigation policies by mapping supervision to specific infrastructure service configuration policies/parameters (e.g., map supervision to specific infrastructure for the virtualized infrastructure manager (VIM) configuration and scaling policies, including, as examples, rules for scale-up, scale-down, and/or moving workloads; power-aware placement decisions; etc. Next the guidance/supervision system may, in 525, generate a supervision tracking metadata context. The supervision tracking metadata context may be provided in 555, to a supervisor that may configure an analytics system with monitor source supervisor change tracking contexts, etc., that are tied to a specific guidance. This may then be provided to, in 560, an analytics system that provides for monitoring the impact of human supervision and guidance over the autonomous system. If necessary (e.g., to address an impact to or issue with a service level objective (SLO)), the guidance/supervision system may apply, in 570, supervisory mitigations in an attempt to resolve the SLO impact/issue. The guidance/supervision system may also provide an alert to the service owner 501 that there is a deviation from the SLO along with information about the type, extent, and criticality of the deviation, about the selected/proposed mitigation, etc.

The guidance/supervision system may also use, in 530, the supervision tracking metadata context from 425 to apply (pre-deployment) the supervisor mitigations to the system. Then, in 530, the guidance/supervision system may configure and/or deploy monitors. The monitors may be configured or deployed, for example, with resource key performance indicators (KPIs) that may be used to support resource monitoring for the impact of changes in guidance/supervision policies. If the impact is satisfactory, the guidance/supervision system may, in 540, set the configuration parameters/policies for the infrastructure according to the supervision policies. In essence, this may be an override of the autonomous system's configuration parameters/polices for the resources with the supervisor-selected policies. The guidance/supervision system then, in 545, deploy new workloads to the infrastructure using the supervisor-selected policies. The guidance/supervision system may then, in 550, monitor these deployed policies as to the configured KPIs, which may also be provided to the analytics system 560 for monitoring the impact of the new supervision policies. As should be appreciated, the guidance/supervision system may repeat this process to allow for continuous (e.g., real-time) monitoring, updating, and fine-tuning, or intermittently where the process is triggered randomly, at time-based intervals, event-based triggers (e.g., an alert condition), etc.

While FIGS. 4 and 5 show examples of how resource owner(s) and/or service owner(s) may use the guidance/supervision system to influence the overall system, any type and any number of stakeholders may provide guidance/supervision to guide, supervise, and introspectively analyze the overall system. As should be appreciated, when multiple stakeholders provide guidance and/or supervision, the guidance/supervision system may prioritize one stakeholder's preferences over another.

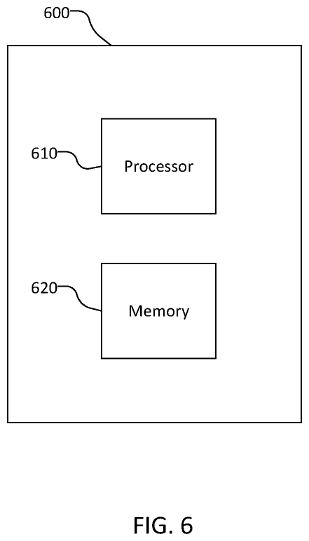

FIG. 6 shows an example of device 600 for guiding, supervising, and introspectively analyzing an autonomous system. Without limitation, device 600 may implement any of the features described above with reference to the disclosed guidance/supervision system (e.g., with respect to guidance/supervision systems 100, 200, 300; and/or FIGS. 1-5). FIG. 6 may be implemented as a device, a system, a method, and/or a computer readable medium that, when executed, performs any of the features of the guidance/supervision systems described above. It should be appreciated that device 600 is merely exemplary, and this example is not intended to limit any part of guidance/supervision system systems 100, 200, or 300.

Device 600 includes a processor 610 configured to determine, based on predefined preferences associated with shared resources, a set of policies to guide an autonomous system in determining a set of configuration parameters for sharing the shared resources. Processor 610 is also configured to provide the set of policies to the autonomous system to configure the shared resources according to the set of configuration parameters. In addition to or in combination with any of the features described in this or the following paragraphs, processor 610 may be further configured to provide to the autonomous system a supervision rule associated with the predefined preferences, wherein the supervision rule defines a mitigation strategy for the autonomous system to resolve a conflict between predefined preferences and/or to determine an efficiency trade-off between predefined preferences. In addition to or in combination with any of the features described in this or the following paragraphs, processor 610 may be further configured to analyze the supervision rule and/or the predefined preferences in order to determine an impact of the supervision rule and/or the predefined preferences on configuring the shared resources. In addition to or in combination with any of the features described in this or the following paragraphs, processor 610 may be further configured to generate a warning if the impact satisfies a warning criterion.

Furthermore, in addition to or in combination with any one of the features of this and/or the preceding paragraph with respect to device 600, wherein the impact includes a misconfiguration of the shared resources, an inefficient configuration of the shared resources, a suboptimal configuration of the shared resources, a conflicting configuration for the shared resources, a failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints. Furthermore, in addition to or in combination with any one of the features of this and/or the preceding paragraph with respect to device 600, the efficiency trade-off may include an optimization of the predefined preferences for achieving a predefined behavior metric associated with a usage context of the shared resources. Furthermore, in addition to or in combination with any one of the features of this and/or the preceding paragraph with respect to device 600, processor 610 may be further configured to determine the impact based on whether a trigger occurs. Furthermore, in addition to or in combination with any one of the features of this and/or the preceding paragraph with respect to device 600, the trigger may include a time-based interval, a random interval, a user input, and/or a triggering event.

Furthermore, in addition to or in combination with any one of the features of this and/or the preceding two paragraphs with respect to device 600, the impact may include an assessment of an impact area of the supervision rule and/or the predefined preferences. Furthermore, in addition to or in combination with any one of the features of this and/or the preceding two paragraphs with respect to device 600, the impact area may include at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences. Furthermore, in addition to or in combination with any one of the features of this and/or the preceding two paragraphs, device 600 may further include a memory 620 configured to store at least one of the predefined preferences, the set of policies, and/or the set of configuration parameters.

Furthermore, in addition to or in combination with any one of the features of this and/or the preceding three paragraphs with respect to device 600, the predefined preferences may include service level objectives of a consumer of the shared resources and/or a supplier of the shared resources. Furthermore, in addition to or in combination with any one of the features of this and/or the preceding three paragraphs with respect to device 600, the consumer may include a service owner that provides access to a portion of the shared resources to end customers. Furthermore, in addition to or in combination with any one of the features of this and/or the preceding three paragraphs with respect to device 600, the supplier may include a resource owner of a portion of the shared resources. Furthermore, in addition to or in combination with any one of the features of this and/or the preceding three paragraphs with respect to device 600, the policy may include a utility function of operational attributes related to the predefined preferences.

Furthermore, in addition to or in combination with any one of the features of this and/or the preceding four paragraphs with respect to device 600, the utility function may include for each respective operational attribute of the operational attributes a respective weight defining an importance of the respective operational attribute. Furthermore, in addition to or in combination with any one of the features of this and/or the preceding four paragraphs with respect to device 600, the operational attributes may include at least one of a capacity, a cost, a predicted service level objective, a target service level objective, a priority, and/or a headroom of the shared resources. Furthermore, in addition to or in combination with any one of the features of this and/or the preceding four paragraphs with respect to device 600, processor 610 may be configured to determine the predicted service level objective based on a machine learning model of historical information associated with achieving different service level objectives in a predetermined operational context of the shared resources.

Furthermore, in addition to or in combination with any one of the features of this and/or the preceding five paragraphs with respect to device 600, processor 610 may be further configured to provide the set of policies as a recommended set of policies to a user. The processor 610 may also be configured to modify the set of policies to an alternative set of policies if an input from the user indicates that the recommended set of policies should be modified to the alternative set of policies. Furthermore, in addition to or in combination with any one of the features of this and/or the preceding five paragraphs with respect to device 600, the group of shared resources may include processing infrastructure, data storage infrastructure, and/or networking infrastructure.

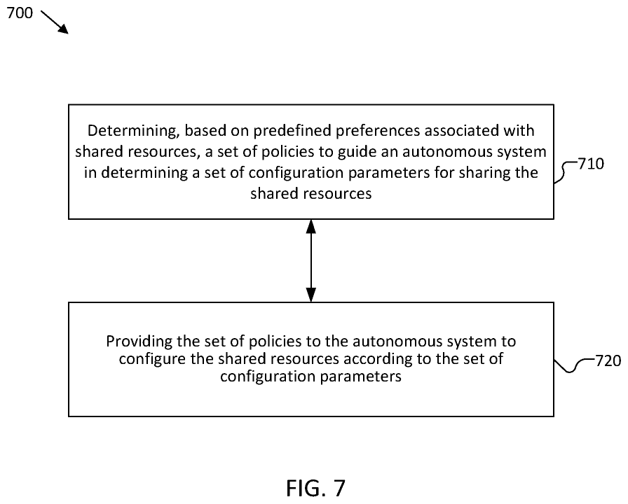

FIG. 7 depicts a schematic flow diagram of a method 700 for guiding, supervising, and introspectively analyzing an autonomous system. Method 1000 may implement any of the features described above with reference to the disclosed guidance/supervision system (e.g., with respect to guidance/supervision systems 100, 200, 300, device 600; and/or FIGS. 1-6).

Method 700 includes, in 710, determining, based on predefined preferences associated with shared resources, a set of policies to guide an autonomous system in determining a set of configuration parameters for sharing the shared resources. Method 700 also includes, in 720, providing the set of policies to the autonomous system to configure the shared resources according to the set of configuration parameters.

In the following, various examples are provided that may include one or more aspects described above with reference to features of the disclosed guidance/supervision system (e.g., with respect to guidance/supervision systems 100, 200, 300, device 600; method 700; and/or FIGS. 1-7). The examples provided in relation to the devices may apply also to the described method(s), and vice versa.

Example 1 is a device including a processor configured to determine, based on predefined preferences associated with shared resources, a set of policies to guide an autonomous system in determining a set of configuration parameters for sharing the shared resources. The processor is also configured to provide the set of policies to the autonomous system to configure the shared resources according to the set of configuration parameters.

Example 2 is the device of example 1, wherein the processor is further configured to provide to the autonomous system a supervision rule associated with the predefined preferences, wherein the supervision rule defines a mitigation strategy for the autonomous system to resolve a conflict between predefined preferences and/or to determine an efficiency trade-off between predefined preferences.

Example 3 is the device of example 2, wherein the processor is further configured to analyze the supervision rule and/or the predefined preferences in order to determine an impact of the supervision rule and/or the predefined preferences on configuring the shared resources. The processor is further configured to generate a warning if the impact satisfies a warning criterion.

Example 4 is the device of example 3, wherein the impact includes a misconfiguration of the shared resources, an inefficient configuration of the shared resources, a suboptimal configuration of the shared resources, a conflicting configuration for the shared resources, a failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints.

Example 5 is the device of example 2, wherein the efficiency trade-off includes an optimization of the predefined preferences for achieving a predefined behavior metric associated with a usage context of the shared resources.

Example 6 is the device of any one of examples 3 to 5, wherein the processor is further configured to determine the impact based on whether a trigger occurs.

Example 7 is the device of example 6, wherein the trigger includes a time-based interval, a random interval, a user input, and/or a triggering event.

Example 8 is the device of any one of examples 3 to 7, wherein the impact includes an assessment of an impact area of the supervision rule and/or the predefined preferences.

Example 9 is the device of example 8, wherein the impact area includes at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences.

Example 10 is the device of any one of examples 1 to 9, the device further including a memory configured to store at least one of the predefined preferences, the set of policies, and/or the set of configuration parameters.

Example 11 is the device of any one of examples 1 to 10, wherein the predefined preferences include service level objectives of a consumer of the shared resources and/or a supplier of the shared resources.

Example 12 is the device of example 11, wherein the consumer includes a service owner that provides access to a portion of the shared resources to end customers.

Example 13 is the device of example 11, wherein the supplier includes a resource owner of a portion of the shared resources.

Example 14 is the device of any one of examples 1 to 13, wherein the policy includes a utility function of operational attributes related to the predefined preferences.

Example 15 is the device of example 14, wherein the utility function includes for each respective operational attribute of the operational attributes a respective weight defining an importance of the respective operational attribute.

Example 16 is the device of example 14, wherein the operational attributes include at least one of a capacity, a cost, a predicted service level objective, a target service level objective, a priority, and/or a headroom of the shared resources.

Example 17 is the device of example 15, wherein the processor is configured to determine the predicted service level objective based on a machine learning model of historical information associated with achieving different service level objectives in a predetermined operational context of the shared resources.

Example 18 the device of any one of examples 1 to 17, wherein the processor is further configured to provide the set of policies as a recommended set of policies to a user. The processor is also configured to modify the set of policies to an alternative set of policies if an input from the user indicates that the recommended set of policies should be modified to the alternative set of policies.

Example 19 is the device of any one of examples 1 to 18, wherein the group of shared resources includes processing infrastructure, data storage infrastructure, and/or networking infrastructure.

Example 20 is a management system for managing a set of configuration parameters of shared resources. The management system includes a policy determination circuit that determines, based on predefined preferences associated with shared resources, a set of policies that guide an autonomous system in determining a set of configuration parameters for sharing the resources. The management system also includes a transmission circuit for providing the policies to the autonomous system to configure the shared resources according to the set of configuration parameters.

Example 21 is the management system of example 20, wherein the transmission circuit is further configured to provide to the autonomous system a supervision rule associated with the predefined preferences, wherein the supervision rule defines a mitigation strategy for the autonomous system to resolve a conflict between predefined preferences and/or to determine an efficiency trade-off between predefined preferences.

Example 22 is the management system of example 21, the management system further including a analysis circuit to analyze the supervision rule and/or the predefined preferences and determine an impact of the supervision rule and/or the predefined preferences on configuring the shared resources. The management system further includes a alarm circuit configured to generate a warning if the impact satisfies a warning criterion.

Example 23 is the management system of example 22, wherein the impact includes a misconfiguration of the shared resources, an inefficient configuration of the shared resources, a suboptimal configuration of the shared resources, a conflicting configuration for the shared resources, failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints.

Example 24 is the management system of example 21, wherein the efficiency trade-off includes an optimization of the predefined preferences for achieving a predefined behavior metric associated with a usage context of the shared resources.

Example 25 is the management system of any one of examples 22 to 24, wherein the analysis circuit is further configured to determine the impact based on whether a trigger occurs.

Example 26 is the management system of example 25, wherein the trigger includes a time-based interval, a random interval, a user input, and/or a triggering event.

Example 27 is the management system of any one of examples 22 to 26, wherein the impact includes an assessment of an impact area of the supervision rule and/or the predefined preferences.

Example 28 is the management system of example 27, wherein the impact area includes at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences.

Example 29 is the management system of any one of examples 20 to 28, wherein the predefined preferences include service level objectives of a consumer of the shared resources and/or a supplier of the shared resources.

Example 30 is the management system of example 29, wherein the consumer includes a service owner that provides access to a portion of the shared resources to end customers.

Example 31 is the management system of example 29, wherein the supplier includes a resource owner of a portion of the shared resources.

Example 32 is the management system of any one of examples 20 to 31, wherein the policy includes a utility function of operational attributes related to the predefined preferences.

Example 33 is the management system of example 32, wherein the utility function includes for each respective operational attribute of the operational attributes a respective weight defining an importance of the respective operational attribute.

Example 34 is the management system of example 32, wherein the operational attributes include at least one of a capacity, a cost, a predicted service level objective, a target service level objective, a priority, and/or a headroom of the shared resources.

Example 35 is the management system of example 33, the management system further including a artificial intelligence circuit configured to determine the predicted service level objective based on a machine learning model of historical information associated with achieving different service level objectives in a predetermined operational context of the shared resources.

Example 36 the management system of any one of examples 20 to 35, the management system further including a display circuit configured to provide the set of policies as a recommended set of policies to a user. The management system also includes a modification circuit configured to modify the set of policies to an alternative set of policies if an input from the user indicates that the recommended set of policies should be modified to the alternative set of policies.

Example 37 is the management system of any one of examples 20 to 36, wherein the group of shared resources includes processing infrastructure, data storage infrastructure, and/or networking infrastructure.

Example 38 is a method including determining, based on predefined preferences associated with shared resources, a set of policies to guide an autonomous system in determining a set of configuration parameters for sharing the shared resources. The method also includes providing the set of policies to the autonomous system to configure the shared resources according to the set of configuration parameters.

Example 39 is the method of example 38, the method further includes providing to the autonomous system a supervision rule associated with the predefined preferences, wherein the supervision rule defines a mitigation strategy for the autonomous system to resolve a conflict between predefined preferences and/or to determine an efficiency trade-off between predefined preferences.

Example 40 is the method of example 39, the method further including analyzing the supervision rule and/or the predefined preferences in order to determine an impact of the supervision rule and/or the predefined preferences on configuring the shared resources. The method further includes generating a warning if the impact satisfies a warning criterion.

Example 41 is the method of example 40, wherein the impact includes a misconfiguration of the shared resources, an inefficient configuration of the shared resources, a suboptimal configuration of the shared resources, a conflicting configuration for the shared resources, a failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints.

Example 42 is the method of example 39, wherein the efficiency trade-off includes an optimization of the predefined preferences for achieving a predefined behavior metric associated with a usage context of the shared resources.

Example 43 is the method of any one of examples 40 to 42, the method further includes determining the impact based on whether a trigger occurs.

Example 44 is the method of example 43, wherein the trigger includes a time-based interval, a random interval, a user input, and/or a triggering event.

Example 45 is the method of any one of examples 40 to 44, wherein the impact includes an assessment of an impact area of the supervision rule and/or the predefined preferences.

Example 46 is the method of example 45, wherein the impact area includes at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences.

Example 47 is the method of any one of examples 38 to 46, the method further including storing at least one of the predefined preferences, the set of policies, and/or the set of configuration parameters.

Example 48 is the method of any one of examples 38 to 47, wherein the predefined preferences include service level objectives of a consumer of the shared resources and/or a supplier of the shared resources.

Example 49 is the method of example 48, wherein the consumer includes a service owner that provides access to a portion of the shared resources to end customers.

Example 50 is the method of example 48, wherein the supplier includes a resource owner of a portion of the shared resources.

Example 51 is the method of any one of examples 38 to 50, wherein the policy includes a utility function of operational attributes related to the predefined preferences.

Example 52 is the method of example 51, wherein the utility function includes for each respective operational attribute of the operational attributes a respective weight defining an importance of the respective operational attribute.

Example 53 is the method of example 51, wherein the operational attributes include at least one of a capacity, a cost, a predicted service level objective, a target service level objective, a priority, and/or a headroom of the shared resources.

Example 54 is the method of example 52, the method further including determining the predicted service level objective based on a machine learning model of historical information associated with achieving different service level objectives in a predetermined operational context of the shared resources.

Example 55 the method of any one of examples 38 to 54, the method further including providing the set of policies as a recommended set of policies to a user. The processor is also configured to modify the set of policies to an alternative set of policies if an input from the user indicates that the recommended set of policies should be modified to the alternative set of policies.

Example 56 is the method of any one of examples 38 to 55, wherein the group of shared resources includes processing infrastructure, data storage infrastructure, and/or networking infrastructure.

Example 57 is a device including a means for determining, based on predefined preferences associated with shared resources, a set of policies to guide an autonomous system in determining a set of configuration parameters for sharing the shared resources. The device also includes and means for providing the set of policies to the autonomous system to configure the shared resources according to the set of configuration parameters.

Example 58 is the device of example 57, wherein the device further includes a means for providing to the autonomous system a supervision rule associated with the predefined preferences, wherein the supervision rule defines a mitigation strategy for the autonomous system to resolve a conflict between predefined preferences and/or to determine an efficiency trade-off between predefined preferences.

Example 59 is the device of example 58, wherein the device further includes a means for analyzing the supervision rule and/or the predefined preferences in order to determine an impact of the supervision rule and/or the predefined preferences on configuring the shared resources. The processor is further configured to generate a warning if the impact satisfies a warning criterion.

Example 60 is the device of example 59, wherein the impact includes a misconfiguration of the shared resources, an inefficient configuration of the shared resources, a suboptimal configuration of the shared resources, a conflicting configuration for the shared resources, a failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints.

Example 61 is the device of example 58, wherein the efficiency trade-off includes an optimization of the predefined preferences for achieving a predefined behavior metric associated with a usage context of the shared resources.

Example 62 is the device of any one of examples 59 to 61, wherein the device further includes a means for determining the impact based on whether a trigger occurs.

Example 63 is the device of example 62, wherein the trigger includes a time-based interval, a random interval, a user input, and/or a triggering event.

Example 64 is the device of any one of examples 59 to 63, wherein the impact includes an assessment of an impact area of the supervision rule and/or the predefined preferences.

Example 65 is the device of example 64, wherein the impact area includes at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences.

Example 66 is the device of any one of examples 57 to 65, the device further including a means for storing at least one of the predefined preferences, the set of policies, and/or the set of configuration parameters.

Example 67 is the device of any one of examples 57 to 66, wherein the predefined preferences include service level objectives of a consumer of the shared resources and/or a supplier of the shared resources.

Example 68 is the device of example 67, wherein the consumer includes a service owner that provides access to a portion of the shared resources to end customers.

Example 69 is the device of example 67, wherein the supplier includes a resource owner of a portion of the shared resources.

Example 70 is the device of any one of examples 57 to 69, wherein the policy includes a utility function of operational attributes related to the predefined preferences.

Example 71 is the device of example 70, wherein the utility function includes for each respective operational attribute of the operational attributes a respective weight defining an importance of the respective operational attribute.

Example 72 is the device of example 70, wherein the operational attributes include at least one of a capacity, a cost, a predicted service level objective, a target service level objective, a priority, and/or a headroom of the shared resources.

Example 73 is the device of example 71, wherein the device further includes determining the predicted service level objective based on a machine learning model of historical information associated with achieving different service level objectives in a predetermined operational context of the shared resources.

Example 74 the device of any one of examples 57 to 73, wherein the device further includes a means for providing the set of policies as a recommended set of policies to a user. The processor is also configured to modify the set of policies to an alternative set of policies if an input from the user indicates that the recommended set of policies should be modified to the alternative set of policies.

Example 75 is the device of any one of examples 57 to 74, wherein the group of shared resources includes processing infrastructure, data storage infrastructure, and/or networking infrastructure.

Example 76 is a is a non-transitory computer readable medium that includes instructions, which if executed, cause one or more processors to determine, based on predefined preferences associated with shared resources, a set of policies to guide an autonomous system in determining a set of configuration parameters for sharing the shared resources. The instructions also cause the one or more processors to provide the set of policies to the autonomous system to configure the shared resources according to the set of configuration parameters.

Example 77 is the non-transitory computer readable medium of example 76, wherein the instructions also cause the one or more processors to provide to the autonomous system a supervision rule associated with the predefined preferences, wherein the supervision rule defines a mitigation strategy for the autonomous system to resolve a conflict between predefined preferences and/or to determine an efficiency trade-off between predefined preferences.

Example 78 is the non-transitory computer readable medium of example 77, wherein the instructions also cause the one or more processors to analyze the supervision rule and/or the predefined preferences in order to determine an impact of the supervision rule and/or the predefined preferences on configuring the shared resources. The instructions also cause the one or more processors to generate a warning if the impact satisfies a warning criterion.

Example 79 is the non-transitory computer readable medium of example 78, wherein the impact includes a misconfiguration of the shared resources, an inefficient configuration of the shared resources, a suboptimal configuration of the shared resources, a conflicting configuration for the shared resources, a failure to satisfy the predefined preferences and/or supervision rule, a length of operating time outside a service level agreement, a detection of a service outage, an exceeded service error threshold, a detected service performance indicator anomaly, a detected infrastructure anomaly, a received security alert, a satisfaction of a scaling event upper limit, and/or a detection of a new deployment that may cause resource constraints.

Example 80 is the non-transitory computer readable medium of example 77, wherein the efficiency trade-off includes an optimization of the predefined preferences for achieving a predefined behavior metric associated with a usage context of the shared resources.

Example 81 is the non-transitory computer readable medium of any one of examples 78 to 80, wherein the processor is further configured to determine the impact based on whether a trigger occurs.

Example 82 is the non-transitory computer readable medium of example 81, wherein the trigger includes a time-based interval, a random interval, a user input, and/or a triggering event.

Example 83 is the non-transitory computer readable medium of any one of examples 78 to 82, wherein the impact includes an assessment of an impact area of the supervision rule and/or the predefined preferences.

Example 84 is the non-transitory computer readable medium of example 83, wherein the impact area includes at least one of a latency, a jitter, a throughput, a scalability, an availability, a safety, a predictability, a trustworthiness, a riskiness, a privacy level, a confidentiality, a power consumption, a carbon footprint, or an amount of green house gas generation if operating the shared resources with the supervision rule and/or the predefined preferences.

Example 85 is the non-transitory computer readable medium of any one of examples 76 to 84, instructions also cause the one or more processors to store (e.g., in a memory) at least one of the predefined preferences, the set of policies, and/or the set of configuration parameters.

Example 86 is the non-transitory computer readable medium of any one of examples 76 to 85, wherein the predefined preferences include service level objectives of a consumer of the shared resources and/or a supplier of the shared resources.

Example 87 is the non-transitory computer readable medium of example 86, wherein the consumer includes a service owner that provides access to a portion of the shared resources to end customers.

Example 88 is the non-transitory computer readable medium of example 86, wherein the supplier includes a resource owner of a portion of the shared resources.

Example 89 is the non-transitory computer readable medium of any one of examples 76 to 88, wherein the policy includes a utility function of operational attributes related to the predefined preferences.

Example 90 is the non-transitory computer readable medium of example 89, wherein the utility function includes for each respective operational attribute of the operational attributes a respective weight defining an importance of the respective operational attribute.

Example 91 is the non-transitory computer readable medium of example 89, wherein the operational attributes include at least one of a capacity, a cost, a predicted service level objective, a target service level objective, a priority, and/or a headroom of the shared resources.

Example 92 is the non-transitory computer readable medium of example 90, wherein the instructions also cause the one or more processors to determine the predicted service level objective based on a machine learning model of historical information associated with achieving different service level objectives in a predetermined operational context of the shared resources.

Example 93 the non-transitory computer readable medium of any one of examples 76 to 92, wherein the instructions also cause the one or more processors to provide the set of policies as a recommended set of policies to a user. The processor is also configured to modify the set of policies to an alternative set of policies if an input from the user indicates that the recommended set of policies should be modified to the alternative set of policies.

Example 94 is the non-transitory computer readable medium of any one of examples 76 to 93, wherein the group of shared resources includes processing infrastructure, data storage infrastructure, and/or networking infrastructure.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
determine, based on predefined preferences associated with shared resources, a set of policies to guide an autonomous system in determining a set of configuration parameters for sharing the shared resources; and
provide the set of policies to the autonomous system to configure the shared resources according to the set of configuration parameters.

2. The device of claim 1, wherein the processor is further configured to provide to the autonomous system a supervision rule associated with the predefined preferences, wherein the supervision rule defines a mitigation strategy for the autonomous system to resolve a conflict between the redefined preferences or to determine an efficiency trade-off between the predefined preferences.

3. The device of claim 2, wherein the processor is further configured to:
analyze the supervision rule or the predefined preferences in order to determine an impact of the supervision rule or the predefined preferences on configuring the shared resources; and
generate a warning if the impact satisfies a warning criterion.

4. The device of claim 3, wherein the impact comprises at least one of a misconfiguration of the shared resources, an inefficient configuration of the shared resources, a suboptimal configuration of the shared resources, a conflicting configuration for the shared resources, and a failure to satisfy the predefined preferences or supervision rule.

5. The device of claim 2, wherein the efficiency trade-off comprises an optimization of the predefined preferences for achieving a predefined behavior metric associated with a usage context of the shared resources.

6. The device of claim 3, wherein the processor is further configured to determine the impact based on whether a trigger occurs.

7. The device of claim 6, wherein the trigger comprises at least one of a time-based interval, a random interval, a user input, and a triggering event.

8. The device of claim 3, wherein the impact comprises an assessment of an impact area of the supervision rule or of the predefined preferences.

9. The device of claim 8, wherein the impact area comprises at least one of a latency, a jitter, a throughput, a scalability, an availability, a safety, a predictability, a trustworthiness, a riskiness, a privacy level, a confidentiality, a power consumption, a carbon footprint, and an amount of green house gas generation if operating the shared resources with the supervision rule or the predefined preferences.

10. The device of claim 1, the device further comprising a memory configured to store at least one of the predefined preferences, the set of policies, and the set of configuration parameters.

11. The device of claim 1, wherein the policy comprises a utility function of operational attributes related to the predefined preferences, wherein the utility function comprises for each respective operational attribute of the operational attributes a respective weight defining an importance of the respective operational attribute.

12. The device of claim 11, wherein at least one of the operational attributes comprise at least one of a capacity, a cost, a predicted service level objective, a target service level objective, a priority, and a headroom of the shared resources.

13. The device of claim 11, wherein the processor is configured to determine the predicted service level objective based on a machine learning model of historical information associated with achieving different service level objectives in a predetermined operational context of the shared resources.

14. A management system for managing a set of configuration parameters of shared resources, the management system comprising:
a policy determination circuit that determines, based on predefined preferences associated with shared resources, a set of policies that guide an autonomous system in determining a set of configuration parameters for sharing the resources; and
a transmission circuit for providing the policies to the autonomous system to configure the shared resources according to the set of configuration parameters.

15. The management system of claim 14, the management system further comprising:
a display circuit configured to provide the set of policies as a recommended set of policies to a user; and
a modification circuit configured to modify the set of policies to an alternative set of policies if an input from the user indicates that the recommended set of policies should be modified to the alternative set of policies.

16. The management system of claim 14, wherein the group of shared resources comprises at least one of processing infrastructure, data storage infrastructure, and networking infrastructure.

17. A non-transitory computer readable medium comprising instructions, which if executed, cause one or more processors to:
determine, based on predefined preferences associated with shared resources, a set of policies to guide an autonomous system in determining a set of configuration parameters for sharing the shared resources; and
provide the set of policies to the autonomous system to configure the shared resources according to the set of configuration parameters.

18. The non-transitory computer readable medium of claim 17, wherein the predefined preferences comprise service level objectives of a consumer of the shared resources or a supplier of the shared resources.

19. The non-transitory computer readable medium of claim 18, wherein the consumer comprises a service owner that provides access to a portion of the shared resources to end customers.

20. The non-transitory computer readable medium of claim 18, wherein the supplier comprises a resource owner of a portion of the shared resources.
